(19) United States
(12) Patent Application Publication
(10) Pub. No.: US 2024/0330231 A1
(43) Pub. Date: Oct. 3, 2024

(54) COMMUNICATION INTERFACE CHIP AND ADDRESS EXTENSION CIRCUIT THEREOF

(71) Applicant: Silergy Semiconductor Technology (Hangzhou) LTD, Hangzhou (CN)

(72) Inventors: Zongquan Zhang, Hangzhou (CN); Xiaoqiang Xu, Hangzhou (CN); Yuanyu Yang, Hangzhou (CN)

(21) Appl. No.: 18/616,411

(22) Filed: Mar. 26, 2024

(30) Foreign Application Priority Data
Mar. 31, 2023 (CN) 202310342481.3

(51) Int. Cl. G06F 13/42; G06F 13/40

(52) U.S. Cl. CPC G06F 13/4282; G06F 13/4022

(57) ABSTRACT

An address extension circuit for configuring an address of a chip, can include where: the address extension circuit is configured to encode the address of the chip differently according to different state information of at least one address pin of the chip; and the state information of the address pin is configured to comprise at least one of floating, coupling with a communication input pin of the chip, and coupling with a communication output pin of the chip.

### RELATED APPLICATIONS

This application claims the benefit of Chinese Patent Application No. 202310342481.3, filed on Mar. 31, 2023, which is incorporated herein by reference in its entirety.

### FIELD OF THE INVENTION

The present invention generally relates to the field of communications, and more particularly, to communication interface chips and associated address extension circuitry.

### BACKGROUND

Communication is often needed between a master and multiple slave devices. In order to prevent multiple slaves from colliding when communicating, each slave must have a unique address. The chip of the slave may have one or more address pins for address configuration, and the address of the chip can be configured by connecting the address pin to the power supply (e.g., high level) or the ground (e.g., low level). FIG. 1 shows a schematic circuit diagram of an example address extension circuit. Chip IC1 can include two address pins ADDR0 and ADDR1, and each address pin may have two states (e.g., receiving a high-level signal and a low-level, such that the two address pins of the chip can be configured with four addresses. The address pins ADDR0 and ADDR1 are in different level states, so the chip can be configured with different addresses.

### BRIEF DESCRIPTION OF THE DRAWINGS

FIG. 1 is a schematic circuit diagram of an example address extension circuit.

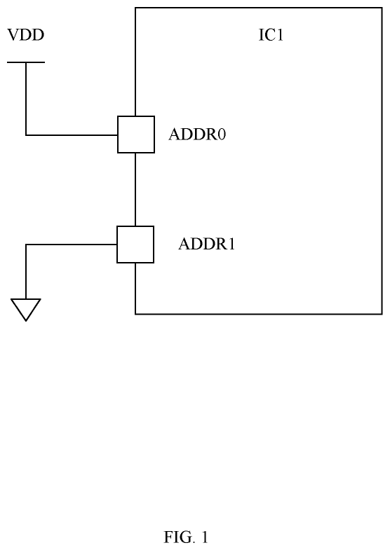

FIG. 2 is a schematic circuit diagram of a first example address extension circuit, in accordance with embodiments of the present invention.

FIG. 3 is a waveform diagram of an example operation of a control circuit, in accordance with embodiments of the present invention.

FIG. 4 is a schematic circuit diagram of a second example address extension circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

In order to realize a multiple addresses configuration for multiple same slaves, each slave needs multiple address pins that form a unique combination, thus forming a different address from other slaves. The more slaves there are in the system, the more address pins of each chip are needed, so the size of the chip increases, and the cost of the system increases accordingly. Therefore, it may be necessary to provide an address extension circuit that can expand the address of the slave without increasing the address pin, in order to solve the defects of the above method.

Particular embodiments may provide an address extension circuit for configuring the address of a chip. The address extension circuit can encode the address of the chip differently according to the state information of at least one address pin of the chip, where the state information of the address pin can include at least one of: floating, coupling with a communication input pin of the chip, and coupling to a communication output pin of the chip.

In one embodiment, the state information of the address pin can include at least three of being in a high-level state, being in a low-level state, floating, coupling with the communication input pin of the chip, and coupling with the communication output pin of the chip, such that one address pin can input three or more different signals, therefore, three or more addresses are configured for the chip. When address configuration is performed in this way, if a chip has N address pins, it can configure at most 5^{N} addresses, which can expand the address of the chip without increasing the address pin.

In particular embodiments, the state information of the address pin can include being in a high-level state, being in a low-level state, floating, and coupling with the communication input pin of the chip. In another example, the state information of the address pin may also be configured to couple with the communication output pin of the chip or other known or unknown types of the state information. Particular embodiments may not limit the number of the state information, and it can be two or more as illustrated herein.

In particular embodiments, the address extension circuit can identify several different level information of the address pin, in order to determine what signals are input by the address pin. The state information of the address pin can be determined, and then the address of the chip can be configured. When identifying that the level information is a fixed level state, the state information can be determined as being in the high-level state or the low-level state. When identifying that the level information can change according to the change of the level state inside the chip, the state information can be determined as floating. When identifying that the level information is equivalent to the PWM signal received by the address pin, and the PWM signal presents high and low level states within a certain time interval, the state information can be determined as coupling with the communication input pin, the communication output pin, or other substitute pins of the chip. After determining the state information of the address pin, the address extension circuit can encode the address of the chip differently according to the different state information. Any suitable address extension circuit that identifies several different level information of the address pin to determine the state information of the address pin and then perform address coding can be accommodated in certain embodiments.

In one embodiment, the address extension circuit can include a level acquisition circuit including a first power switch and a second power switch connected in series between a power supply and a ground potential terminal in sequence, where the common terminal of the first and second power switches is coupled to the address pin. In the detection interval, the first power switch and the second power switch can be turned on in a time-sharing manner, and the state information of the address pin may be determined according to the voltage of the common terminal of the first and second power switches, in order to encode the address of the chip. It should be understood that time-sharing conduction may indicate that the entities are not conducting at the same time. For example, when the first power switch is turned on, the second power switch can be turned off, and when the second power switch is turned on, the first power switch may be turned off.

In the detection interval, the communication input pin or communication output pin of the chip can output a pulse-width modulation (PWM) signal, that is, a signal with level inversion. During the turn-on period of the first power switch and/or the turn-on period of the second power switch, at least one pulse edge transition of the PWM signal can be included. For example, when the first and second power switches are turned on in a time-sharing manner, the voltage of the common terminal of the first and second power switches can be at a high level, it may be determined that the address pin may be at a high level. That is, the address pin can be coupled to the power supply pin of the chip or to the power supply terminal of other devices or other chips outside the chip. When the first and second power switches are turned on in a time-sharing manner, the voltage of the common terminal of the first and second power switches may be at a low level, and it can be determined that the address pin is at a low level. That is, the address pin can be coupled to the ground potential pin of the chip or to the ground potential terminal of other devices or other chips outside the chip or a common ground potential terminal.

When the first power switch is turned on, the voltage of the common terminal of the first and second power switches may be at a high level, and when the second power switch is turned on, the voltage of the common terminal of the first and second power switches may be at a low level, and it can be determined that the address pin is floating. In the detection interval, the communication input pin of the chip can output a PWM signal. When the first and second power switches are turned on in a time-sharing manner, the PWM signal may have both a high level and a low level, such that the voltage of the common terminal of the first and second power switches may have both a high level and a low level in both a turn-on period of the first power switch and a turn-on period of the second power switch. That is, during the turn-on period of the first power switch, the voltage of the common terminal may have both a high level and a low level, and during the turn-on period of the second power switch, the voltage of the common terminal may have both a high level and a low level, and it can be determined that the address pin is coupled to the communication input pin.

In other embodiments, in the detection interval, the communication output pin of the chip may output a PWM signal, and when the first and second power switches are turned on in a time-sharing manner, the PWM signal may have both a high level and a low level, such that the voltage of the common terminal of the first and second power switches may have both a high level and a low level in both a turn-on period of the first power switch and a turn-on period of the second power switch, and it can be determined that the address pin is coupled to the communication output pin. Therefore, the communication input pin and/or the communication output pin can be replaced by other pins of the chip, as long as it is ensured that the address pin may receive a PWM signal which has both a high level and a low level during the time-sharing conduction period of the first and second power switches. For example, the PWM signal may have a high level and a low level in the turn-on period of the first power switch, and may have a high level and a low level in the turn-on period of the second power switch. In the detection interval, the communication input pin, communication output pin, or other substitute pin, may output the PWM signal, and at other times, the communication input pin, communication output pin, or other substitute pin, may have other functions.

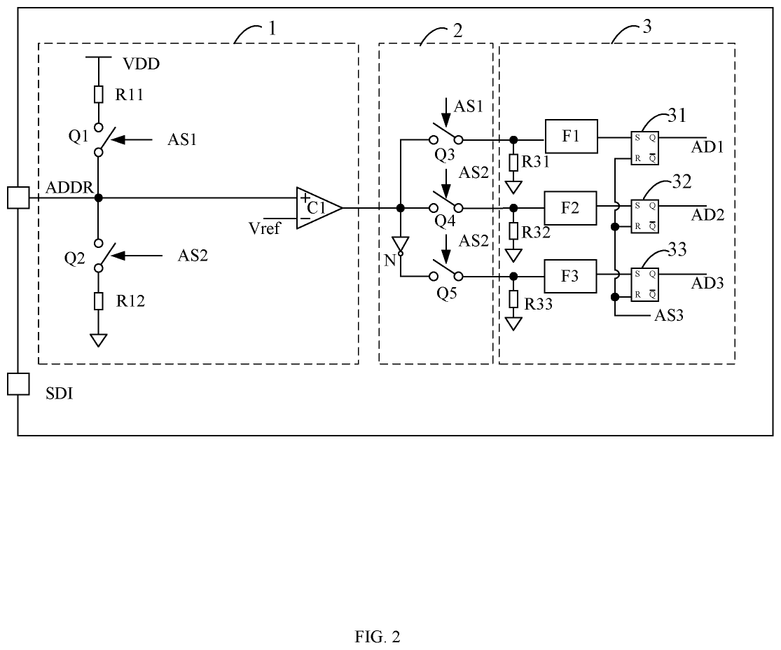

Referring now to FIG. 2, shown is a schematic circuit diagram of a first example address extension circuit, in accordance with embodiments of the present invention. In this particular example, the address extension circuit can include level acquisition circuit 1, gating circuit 2, and level information processing circuit 3. Level acquisition circuit 1 can include first power switch Q1 and second power switch Q2, which are sequentially connected in series between power supply VDD and the ground potential terminal, and the common terminal of the first and second power switches Q1 and Q2 can be coupled to address pin ADDR. In the detection interval, power switches Q1 and Q2 can be turned on in a time-sharing manner, and the state information of the address pin may be determined according to the voltage of the common terminal of power switches Q1 and Q2, in order to encode the address of the chip. Gating circuit 2 can transfer a first signal representing the level information of the address pin generated by level acquisition circuit 1 and the inverted signal of the first signal to level information processing circuit 3 in a time-sharing manner. Level information processing circuit 3 can latch the first signal representing the level information of the address pin and the inverted signal of the first signal, in order to obtain a plurality of state indication signals, whereby the plurality of state indication signals are used to represent the state information of the address pin.

In one embodiment, level acquisition circuit 1 can also include a comparison circuit for comparing the voltage of the common terminal of power switches Q1 and Q2 with a first reference voltage to obtain a first signal representing the level information of the address pin. In this example, the comparison circuit can include comparator C1, whereby the non-inverting input terminal of comparator C1 can be coupled to the common terminal of first and second power switches Q1 and Q2, the inverting input terminal of comparator C1 may receive first reference voltage Vref, and the output terminal of comparator C1 can generate the first signal representing the level information of the address pin. In other examples, the input signals of the two input terminals of comparator C1 can be switched and the logic of the subsequent circuit can be adjusted accordingly.

For example, when first power switch Q1 is turned on, gating circuit 2 may transmit the first signal representing the level information of the address pin to level information processing circuit 3 to generate first state indication signal AD1. When power switch Q2 is turned on, gating circuit 2 may transmit the first signal representing the level information of the address pin to level information processing circuit 3 to generate second state indication signal AD2, and gating circuit 2 may transmit the inverted signal of the first signal representing the level information of the address pin to level information processing circuit 3 to generate third state indication signal AD3. Any suitable circuit that can realize the function of transmitting the first signal representing the level information of the address pin generated by level acquisition circuit 1 and the inverted signal of the first signal to level information processing circuit 3 in the time-sharing manner to generate the state indication signals can be utilized in certain embodiments.

During the turn-on period of power switch Q1, when the first signal has a high level, state indication signal AD1 can be held or latched at a high level during the detection interval. During the turn-on period of power switch Q2, when the first signal has a high level, state indication signal AD2 can be held or latched at a high level during the detection interval, and when the first signal has a low level, state indication signal AD3 may be held or latched at a high level during detection interval.

In this embodiment, level information processing circuit 3 can include RS latches or flip-flops 31, 32, and 33. When power switch Q1 is turned on, gating circuit 2 may transmit the first signal to set terminal S of RS latch 31, and output terminal Q of RS latch 31 can generate state indication signal AD1. When power switch Q2 is turned on, gating circuit 2 may transmit the first signal to set terminal S of RS latch 32, and output terminal Q of RS latch 32 can generate state indication signal AD2. Also, gating circuit 2 may transmit the inverted signal of the first signal to set terminal S of RS latch 33, and output terminal Q of RS latch 33 can generate state indication signal AD3.

In particular embodiments, the output terminal of comparator C1 is the output terminal of level acquisition circuit 1, and gating circuit 2 can include power switches Q3, Q4, and Q5. For example, the first terminal of power switch Q3 can be coupled to the output terminal of comparator C1, and the second terminal of power switch Q3 can be coupled to set terminal S of RS latch 31, the first terminal of power switch Q4 can be coupled to the output terminal of comparator C1, and the second terminal of power switch Q4 can be coupled to set terminal S of RS latch 32. Also, the first terminal of power switch Q5 can be coupled to the output terminal of comparator C1 through inverter N, and the second terminal of power switch Q5 can be coupled to set terminal S of RS latch 33.

In particular embodiments, when state indication signals AD1 is at a high level, state indication signal AD2 is at a high level, and state indication signal AD3 is at a low level, this may indicate that address pin ADDR is at a high level. When state indication signal AD1 is at a low level, state indication signal AD2 is at a low level, and state indication signal AD3 is at a high level, this may indicate that address pin ADDR is at a low level. When state indication signal AD1 is at a high level, state indication signal AD2 is at a low level, and state indication signal AD3 is at a high level, this may indicate that address pin ADDR is floating. When state indication signal AD1 is at a high level, state indication signal AD2 is at a high level, and state indication signal AD3 is at a high level, this may indicate that address pin ADDR is coupled to communication input pin SDI. In other examples, communication input pin SDI can be replaced by a communication output pin or another substitute pin.

In this example, level acquisition circuit 1 can also include resistors R11 and R12. Resistor R11 can be coupled between power supply VDD and power switch Q1, and resistor R12 can be coupled between power switch Q2 and the ground potential terminal. In another example, resistor R11 can be coupled between power switch Q1 and the common terminal, and resistor R12 may be coupled between the common terminal and power switch Q2. That is, the positions resistor R11 and power switch Q1 can switch, the positions of resistor R12 and power switch Q2 can switch.

In this embodiment, level information processing circuit 3 can also include filter circuits F1, F2, and F3 to filter the signals output by gate circuit 2, respectively. For example, filter circuit F1 can be coupled between power switch Q3 and RS latch 31, filter circuit F2 can be coupled between power switch Q4 and RS latch 32, and filter circuit F3 can be coupled between power switch Q5 and RS latch 33. In this example, level information processing circuit 3 further can include resistors R31, R32, and R33. Resistor R31 can be coupled between the common terminal of power switch Q3 and filter circuit F1 and the ground potential terminal, resistor R32 can be coupled between the common terminal of power switch Q4 and filter circuit F2 and the ground potential terminal, and resistor R33 can be coupled between the common terminal of power switch Q5 and filter circuit F3 and the ground potential terminal. In another example, resistor R31 can be coupled between the common terminal of power switch Q3 and filter circuit F1 and power supply VDD, resistor R32 can be coupled between the common terminal of power switch Q4 and filter circuit F2 and power supply VDD, and resistor R33 can be coupled between the common terminal of power switch Q5 and filter circuit F3 and power supply VDD, and the logic of the related circuits can be adjusted accordingly.

The address extension circuit can also include an encoding circuit configured to encode the address of the chip according to the plurality of state indication signals. For example, in this embodiment, when first state indication signal AD1 is at a high level, second state indication signal AD2 is at a high level, and third state indication signal AD3 is at a low level, the encoding circuit can generate first address 1, for example, 00. When first state indication signal AD1 is at a low level, second state indication signal AD2 is at a low level and third state indication signal AD3 is at a high level, the encoding circuit can generate second address 2, for example, 01. When first state indication signal AD1 is at a high level, second state indication signal AD2 is at a low level, and third state indication signal AD3 is at a high level, the encoding circuit can generate third address 3, for example, 10. When first state indication signal AD1 is at a high level, second state indication signal AD2 is at a high level, and third state indication signal AD3 is at a high level, the encoding circuit can generate fourth address 4, for example, 11.

The address extension circuit further can include a control circuit for generating control signals AS1 and AS2. For example, control signal AS1 can control power switches Q1 and Q3, control signal AS2 can control power switches Q2, Q4, and Q5, and active intervals of control signals AS1 and AS2 may not overlap. Further, the control circuit can also generate control signal AS3. For example, reset terminals R of RS latches 31, 32, and 33 may all receive control signal AS3, and the start moment of the detection interval can be configured as the moment when third control signal AS3 changes from active to inactive.

In the detection interval, communication input pin SDI can output a PWM signal, and both of control signals AS1 and AS2 may have at least one active interval. In the active intervals of control signals AS1 and AS2, at least one pulse edge transition of the PWM signal may be included. When the chip contains N address pins ADDR1-ADDRN, each address pin can correspond to the above-mentioned level acquisition circuit 1, gating circuit 2, and level information processing circuit 3. Also, the encoding circuit can encode the address of the chip according to the state indication signals output by the N level information processing circuits corresponding to the N address pins. Therefore, at most 4^{N} addresses can be configured.

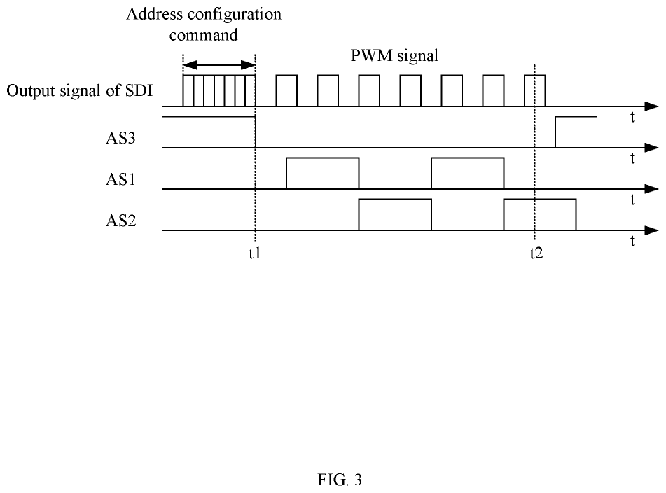

Referring now to FIG. 3, shown is a waveform diagram of an example operation of a control circuit, in accordance with embodiments of the present invention. As shown in FIG. 3, control signals AS1 and AS2 are complementary. However, any scheme in which the active intervals of control signals AS1 and AS2 do not overlap can be utilized in certain embodiments. After the chip is started, communication input pin SDI can send an address configuration command. At moment t1, control signal AS3 may transition from a high level to a low level and the detection interval can begin. In the detection interval, communication input pin SDI can output a PWM signal.

After a period from moment t1, control signal AS1 can be a periodic square wave. For example, the duration of each high level and the duration of each low level in the periodic square wave of control signal AS1 may both be greater than the interval between the rising edge and the falling edge of the PWM signal output by communication input pin SDI (e.g., the duration of each high level the PWM signal). For example, the duration of each low level in the periodic square wave of control signal AS1 can be equal to the duration of each high level in the periodic square wave of control signal AS2 because control signals AS1 and AS2 are complementary. Therefore, after at least one square wave period of control signal AS1, the level states of state indication signals AD1, AD2, and AD3 can be detected by using the above address extension circuit, while the state information of the ADDR pin is different, and the corresponding level states of state indication signals AD1, AD2, and AD3 are different, such that the address of the chip are encoded differently. In this example, detection interval is t1-t2; that is, the level states of state indication signals AD1, AD2, and AD3 may be detected at time t2. Control signal AS3, e.g., may only need to change from low level to high level before the next detection interval comes.

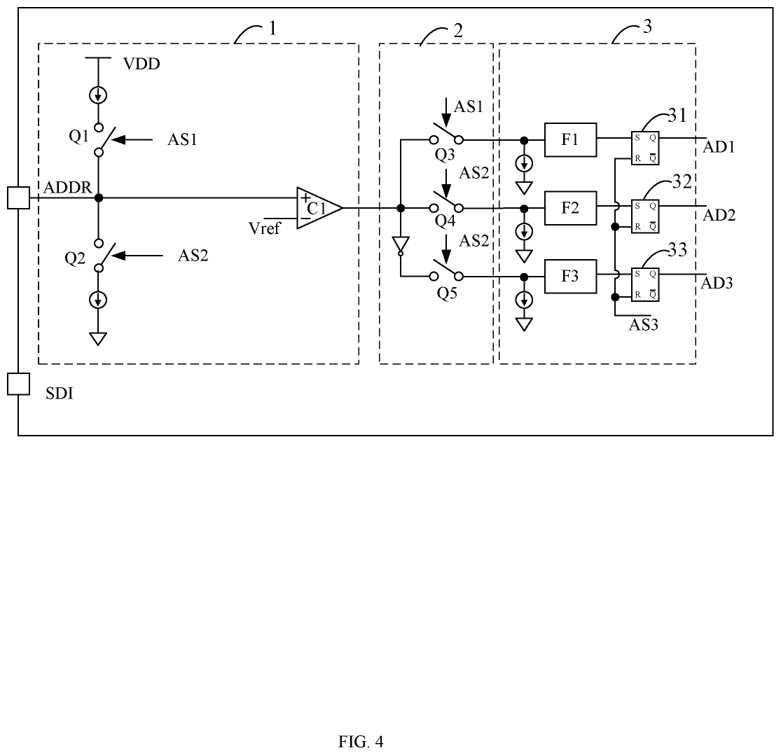

Referring now to FIG. 4, shown is a schematic circuit diagram of a second example address extension circuit, in accordance with embodiments of the present invention. In this particular example, current sources can be utilized instead of resistors, but the functionality can be substantially the same as that discussed above. Particular embodiments may also provide communication interface chip, which can include the address extension circuit described in any one of the above.

The example communication interface chip can include a communication input pin, a communication output pin, and at least one address pin. When the communication interface chip needs address configuration, the state information of the address pin can include at least three of being a high-level state, being a low-level state, coupling to communication input pin, floating, and coupling to communication output pin. In one embodiment, the communication interface chip can also include a power supply pin and a ground potential pin. The state information of the address pin can include at least three of coupling to the communication input pin, coupling to the power supply pin, coupling to the ground potential pin, floating, and coupling to the communication output pin. In another example, the state information of the address pin can include at least three of coupling to the communication input pin, coupling to the power supply terminal of other devices or other chips outside the communication interface chip, coupling to the ground potential terminal of other devices or other chips outside the communication interface chip or common ground potential terminal, coupling to the communication output pin, and floating.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. An address extension circuit for configuring an address of a chip, wherein:
a) the address extension circuit is configured to encode the address of the chip differently according to different state information of at least one address pin of the chip; and
b) the state information of the address pin is configured to comprise at least one of floating, coupling with a communication input pin of the chip, and coupling with a communication output pin of the chip.

2. The address extension circuit of claim 1, further comprising:
a) a level acquisition circuit having a first power switch and a second power switch coupled in series between a power supply and a ground potential terminal, wherein a common terminal of the first and second power switches is coupled to the address pin; and
b) wherein in a detection interval, the first and second power switches are turned on in a time-sharing manner, and the state information of the address pin is determined according to a voltage of the common terminal of the first and second power switches, in order to encode the address of the chip.

3. The address extension circuit of claim 2, wherein when the first power switch and the second power switch are turned on in a time-sharing manner, the voltage of the common terminal of the first and second power switches is at a high level, a determination is made that the address pin is at a high level.

4. The address extension circuit of claim 2, wherein when the first power switch and the second power switch are turned on in a time-sharing manner, the voltage of the common terminal of the first and second power switches is at a low level, a determination is made that the address pin is at a low level.

5. The address extension circuit of claim 2, wherein when the first power switch is turned on, the voltage of the common terminal of the first and second power switches is at a high level, and when the second power switch is turned on, the voltage of the common terminal of the first and second power switches is at a low level, a determination is made that the address pin is floating.

6. The address extension circuit of claim 2, wherein when the first power switch and the second power switch are turned on in a time-sharing manner, the voltage of the common terminal of the first and second power switches has both a high level and a low level in turn-on periods of the first and second power switches, a determination is made that the address pin is coupled with the communication input pin or the communication output pin.

7. The address extension circuit of claim 2, the address extension circuit further comprises:
a) a gating circuit configured to transmit a first signal representing level information of the address pin generated by the level acquisition circuit and an inverted signal of the first signal to a level information processing circuit in a time-sharing manner; and
b) the level information processing circuit being configured to latch the first signal representing the level information of the address pin and the inverted signal of the first signal to obtain a plurality of state indication signals, wherein the plurality of state indication signals represent the state information of the address pin.

8. The address extension circuit of claim 7, wherein the level acquisition circuit further comprises a comparison circuit for comparing the voltage of the common terminal of the first and second power switches against a first reference voltage, in order to obtain the first signal representing the level information of the address pin.

9. The address extension circuit of claim 7, wherein:
a) when the first power switch is turned on, the gating circuit transmits the first signal representing the level information of the address pin to the level information processing circuit to generate a first state indication signal; and
b) when the second power switch is turned on, the gating circuit transmits the first signal representing the level information of the address pin to the level information processing circuit to generate a second state indication signal, and the gating circuit transmits the inverted signal of the first signal to the level information processing circuit to generate a third state indication signal.

10. The address extension circuit of claim 7, wherein:
a) the level information processing circuit comprises a first RS latch, a second RS latch, and a third RS latch;
b) when the first power switch is turned on, the gating circuit transmits the first signal to a set terminal of the first RS latch, and an output terminal of the first RS latch generates a first state indication signal; and
c) when the second power switch is turned on, the gating circuit transmits the first signal to a set terminal of the second RS latch, an output terminal of the second RS latch generates a second state indication signal, the gating circuit transmits the inverted signal of the first signal to a set terminal of the third RS latch, and an output terminal of the third RS latch generates a third state indication signal.

11. The address extension circuit of claim 9, wherein:
a) during a turn-on period of the first power switch, when the first signal has a high level, the first state indication signal is maintained at a high level during the detection interval; and
b) during a turn-on period of the second power switch, when the first signal has a high level, the second state indication signal is maintained at a high level during the detection interval, and when the first signal has a low level, the third state indication signal is maintained at a high level during the detection interval.

12. The address extension circuit of claim 11, wherein:
a) when the first state indication signal is at a high level, the second state indication signal is at a high level, and the third state indication signal is at a low level, this indicates that the address pin is at a high level;
b) when the first state indication signal is at a low level, the second state indication signal is at a low level, and the third state indication signal is at a high level, this indicates that the address pin is at a low level;
c) when the first state indication signal is at a high level, the second state indication signal is at a low level, and the third state indication signal is at a high level, this indicates that the address pin is floating; and
d) when the first state indication signal is at a high level, the second state indication signal is at a high level, and the third state indication signal is at a high level, this indicates that the address pin is coupled with the communication input pin or the communication output pin.

13. The address extension circuit of claim 10, wherein the gate circuit comprises:
a) a third power switch having a first terminal coupled to an output terminal of the level acquisition circuit and a second terminal coupled to the set terminal of the first RS latch;
b) a fourth power switch having a first terminal coupled to the output terminal of the level acquisition circuit and a second terminal coupled to the set terminal of the second RS latch;
c) a fifth power switch having a first terminal coupled to the output terminal of the level acquisition circuit through a first inverter and a second terminal coupled to the set terminal of the third RS latch; and
d) wherein switching states of the third power switch and the first power switch are the same, and switching states of the fourth power switch, the fifth power switch and the second power switch are the same.

14. The address extension circuit of claim 7, wherein the address extension circuit further includes an encoding circuit configured to encode the address of the chip according to the plurality of state indication signals.

15. The address extension circuit of claim 14, wherein the encoding circuit is configured to:
a) when the first state indication signal is at a high level, the second state indication signal is at a high level, and the third state indication signal is at a low level, the address of the chip is encoded as a first address;
b) when the first state indication signal is at a low level, the second state indication signal is at a low level, and the third state indication signal is at a high level, the address of the chip is encoded as a second address;
c) when the first state indication signal is at a high level, the second state indication signal is at a low level, and the third state indication signal is at a high level, the address of the chip is encoded as a third address; and
d) when the first state indication signal is at a high level, the second state indication signal is at a high level, and the third state indication signal is at a high level, the address of the chip is encoded as a fourth address.

16. The address extension circuit of claim 13, further comprising a control circuit for generating a first control signal and a second control signal, wherein the first control signal is configured to control the first power switch and the third power switch, the second control signal is configured to control the second power switch, the fourth power switch and the fifth power switch, and active intervals of the first control signal and the second control signal do not overlap.

17. The address extension circuit of claim 16, wherein:
a) during the detection interval, the communication input pin or the communication output pin outputs a PWM signal, and both the first control signal and the second control signal have at least one active interval; and
b) during the active intervals of the first control signal and the second control signal, at least one pulse edge transition of the PWM signal occurs.

18. The address extension circuit of claim 1, wherein the state information of the address pin comprises at least three of being in a high-level state, being in a low-level state, floating, coupling with the communication input pin, and coupling with the communication output pin.

19. A communication interface chip, comprising the address extension circuit of claim 1 configured in an integrated circuit.

20. The communication interface chip of claim 19, further comprising:
a) a communication input pin, a communication output pin, and at least one address pin; and
b) wherein when the communication interface chip needs address configuration, the state information of the address pin is configured to have at least three of: being in a high-level state, being in a low-level state, coupling with the communication input pin, floating, and coupling with the communication output pin.
